(19) United States
(12) Patent Application Publication
(10) Pub. No.: US 2005/0039855 A1
(43) Pub. Date: Feb. 24, 2005

(54) Apparatus for connecting planar plastic materials

(76) Inventors: Jie-Wei Chen, Alpnach Dorf (CH); Marcel Pironato, Sarnen (CH)

Correspondence Address: BACHMAN & LAPOINTE, P.C., 900 CHAPEL STREET, SUITE 1201, NEW HAVEN, CT, 06510, US

(21) Appl. No.: 10/667,853

(22) Filed: Sep. 22, 2003

(30) Foreign Application Priority Data
Aug. 22, 2003 (EP) 03 019 039.1

(51) Int. Cl. B32B 31/00

(52) U.S. Cl. 156/379.6; 156/272.8

(57) ABSTRACT

An apparatus for welding over a large area according to the laser transmission method, in particular for welding plastic strips to form a grid structure. To this end, a multiplicity of processing heads are assembled to form a unit, so that a high production throughput can be achieved. Spacer devices for setting the distance of the top transparent material strips to be welded are also located between the individual processing heads.

### BACKGROUND OF THE INVENTION

The present invention relates to an apparatus for connecting planar plastic materials according to the laser transmission method, in which a top material layer which faces a laser source and is transparent for the laser beam is connected under the application of pressure to a bottom layer which is absorbent for the laser beam, having a processing head for accommodating guide devices for the laser beam and a device for transmitting the laser beam under the application of pressure to the materials to be connected.

This method of plastic welding with a laser beam is generally known and is also referred to as transmission welding. For this plastic welding method, it is important that the materials are restrained with one another during the welding operation, since an important precondition for a good welded connection of the materials by means of laser radiation is not only the dosage of energy but also the neat mechanical contact between the two joining faces to be connected to one another. The reason for this is that the transparent joining member is heated only via the absorbent joining member by thermal contact. The welding quality therefore largely depends on the mechanical clamping condition, for the size of the air gap between two joining members mainly determines the heat conduction quality.

For processing over a large area, it is technically very difficult, on account of the material tolerance and due to bending problems, to completely clamp the entire part to be welded.

The object of the present invention is to propose an apparatus which simultaneously delivers the laser radiation and the pressure force to the current welding spot in a selective manner and in addition makes it possible to carry out welding over a large area.

### SUMMARY OF THE INVENTION

This object is achieved according to the invention by an apparatus for connecting planar plastic materials according to the laser transmission method, in which a top material layer facing a laser source consists of a material which is transparent for the laser beam and a bottom material layer consists of a material which is absorbent for the laser beam, so that the contact surfaces adjoining one another of the two material layers fuse and combine with one another under pressure during the subsequent cooling, having a processing head for accommodating guide devices for the laser beam and a device for transmitting the laser beam under the application of pressure to the material layers to be connected, wherein focussing devices are arranged in the processing head and a rotatable roller which is transparent for the laser beam is arranged at the outlet end facing the material layers, the focussing devices, preferably an integrated lens system, during the setting to the focus plane, interacting with the transparent roller, and the processing head having pressure devices for pressing the material layers together during the joining operation.

Accordingly, the invention has focussing devices in the processing head and a rotatable roller at the outlet end facing material to be connected, this roller being transparent for the laser beam. The width of the roller depends on the connecting seam and, in an arrangement of a plurality of such processing heads next to one another, on the distance which may exist between the parallel connecting seams. In this respect, a ball may also be used for this purpose, although said ball requires larger distances. During the setting to the focus plane between the material layers to be connected, the focussing devices, preferably an integrated lens system, interact with the transparent roller. In addition, the processing head has pressure devices for pressing the workpieces together during the welding operation. The pressure devices may be spring elements or, for example, pneumatic elements, which compensate for different material thicknesses.

According to a further preferred design, passages for injecting air for mounting the roller are arranged in the processing head. This ensures a good rotary movement of the roller in the processing head.

In order to produce a multiplicity of parallel lines, a multiplicity of such processing heads, assisted by the type of construction, can be arranged next to one another. Since a certain distance remains between the individual welded lines due to the overall size, it is possible to fill this gap by a second row having laser heads arranged offset. Narrow transparent rollers (disks) of glass are preferably used. In principle, however, it is also possible for this application to use glass balls instead, the latter being more complicated, since the welding lines or seams are thus always further apart than when using a transparent roller or disk. The roller or disk is preferably made of glass. The processing heads may also be arranged, by way of example, offset from one another as viewed from above so as to form a large V.

According to a preferred design, spacer devices are arranged between the processing heads, these spacer devices engaging between the top layers located under the processing heads. During the feed, these spacer devices ensure that the distance apart, for example at strips welded to one another, is set and thus ensure that a neat straight line can be welded.

In order to minimize the installation space, the processing head can be coupled to a light fiber without focussing devices. The resulting focus point restricts the maximum welding speed. This disadvantage can be compensated for by increasing the number of individual processing heads and thus by higher production efficiency.

In addition, a linear diode laser may also be arranged directly in front of the processing head, this linear diode laser forming linear radiation along the direction of movement in order to preheat the welding zone.

The individual processing heads are assembled together and moved back and forth in a direction of movement. To compensate for unevenness, each processing head can be individually moved pneumatically in the vertical direction. When connecting plastic strips, these plastic strips can be prepared in a grid shape on a movable plate of large area and can be pushed piece by piece into the processing zone of the processing head and welded. The movable plate may also be replaced by a rolling cylinder, the diameter having to be selected to be so large that the area within the processing zone and the processing head is virtually flat. The arrangement of a plurality of processing heads assembled together can then be moved to and fro along the cylinder. The plastic materials are directed into the welding zone by rotation of the cylinder.

In principle, it is also possible to heat the rest surface of the component of large area to be welded or also the cylinder so that the plastic strips are heated before the welding process in order to improve the quality of thermal contact.

Grid structures of large area consisting of plastic strips in which no significant mechanical clamping devices are used can be produced by means of such an apparatus. 100% welding quality is ensured by the apparatus, and a high production throughput is achieved by the arrangement of a multiplicity of processing heads. Such grid structures may be used, for example, as fine screens.

### BRIEF DESCRIPTION OF THE DRAWINGS

The invention is explained in more detail below with reference to an exemplary embodiment in conjunction with the attached drawings, in which:

FIG. 1 shows the schematic representation of a processing head in a partial longitudinal section (A) and a cross section (B);

FIG. 2 shows the perspective representation of an air-mounted processing head;

FIG. 3 shows a multiple processing head consisting of a plurality of individual processing heads;

FIG. 4 shows a multiple processing head having additional spacer devices; and

FIG. 5 shows the schematic representation of a multiple processing head during the welding of plastic strips.

### DETAILED DESCRIPTION

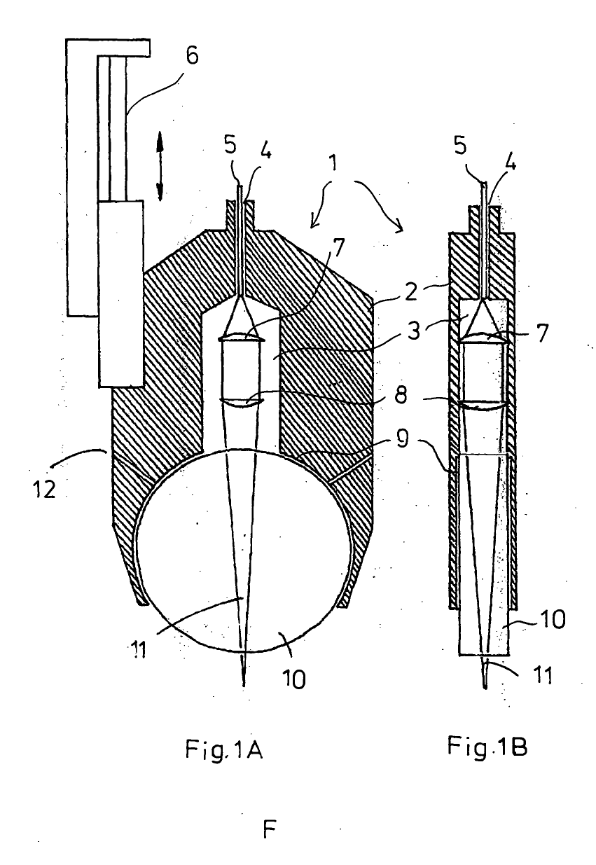

FIG. 1 shows the processing head 1 having a housing 2 which is mounted on a frame (not shown) such as to be movable in the vertical direction by means of a pneumatic piston/cylinder unit 6. The laser beam is introduced into the interior of the housing 2 into a cavity 3 via a light fiber 5 which lies in a bore 4. Correspondingly suitable lenses 7 for forming the laser beam 11 coupled via the light fiber 5 are located in the cavity. Following the cavity 3 is a second cavity 9 for accommodating a disk-shaped glass roller 10, through which the laser beam 11 passes and which is likewise included during the focussing of the laser beam 11 on the desired focus plane. For mounting the disk-shaped glass roller 10, passages 12 for introducing compressed air are provided in the housing.

From the representation according to FIG. 1B, it can be seen that the processing head is determined with regard to its width by the maximum width of the optical elements 7, 8 and the disk-shaped glass roller. The aim in principle is to realize as narrow a processing head as possible for application during the welding of strips.

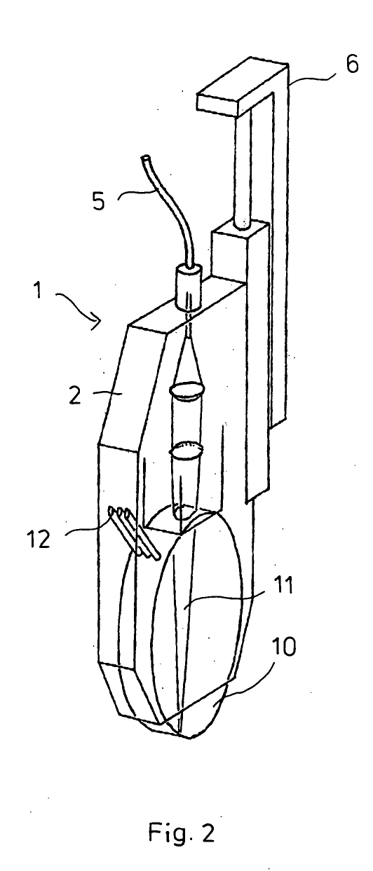

FIG. 2 shows a perspective view of the assembled processing head 1, the piston/cylinder unit being attached directly to the housing 2 directly in the longitudinal axis of the housing 2 in order to realize as narrow a processing head 1 as possible.

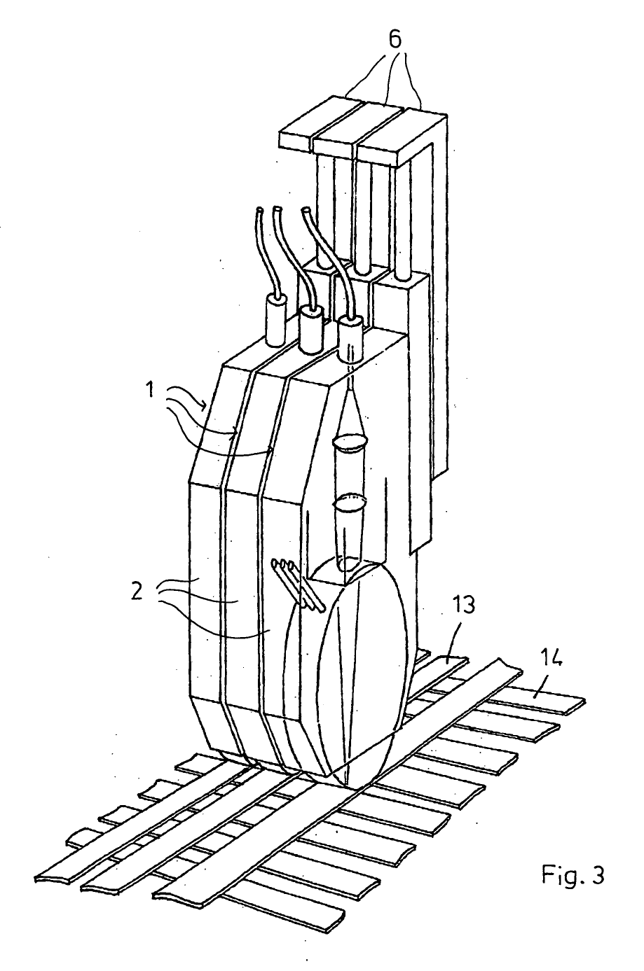

FIG. 3 shows by way of example the assembly of three processing heads of that kind, with plastic strips 13 and 14 to be welded which are arranged underneath, the top plastic strip 13 being transparent and the bottom plastic strip 14 being absorbent for the laser beam 11 in accordance with the method used in this case.

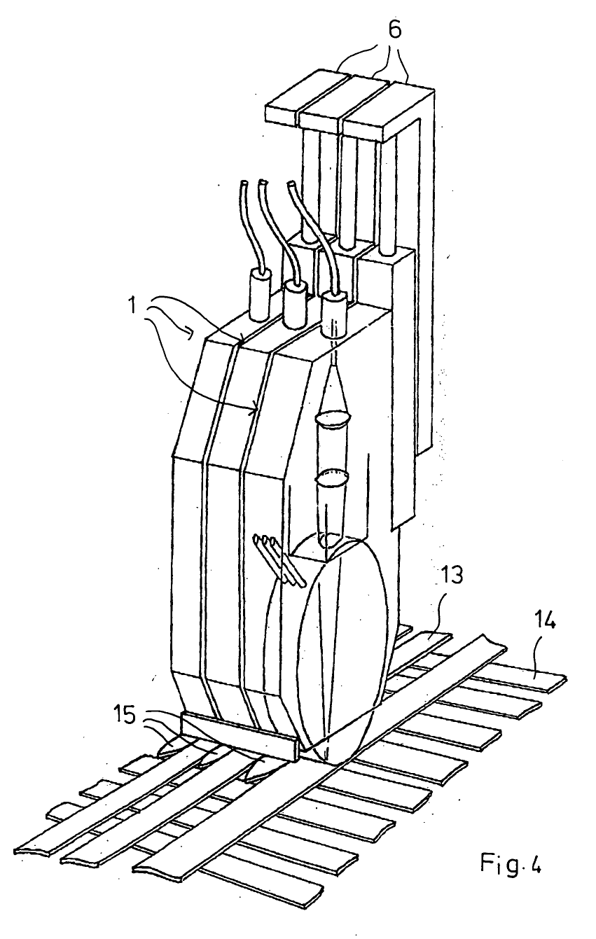

FIG. 4 shows spacer devices 15 which are arranged between the processing heads 1 and ensure that the top transparent material strips 13 are oriented in a straight line and at a predetermined distance from one another.

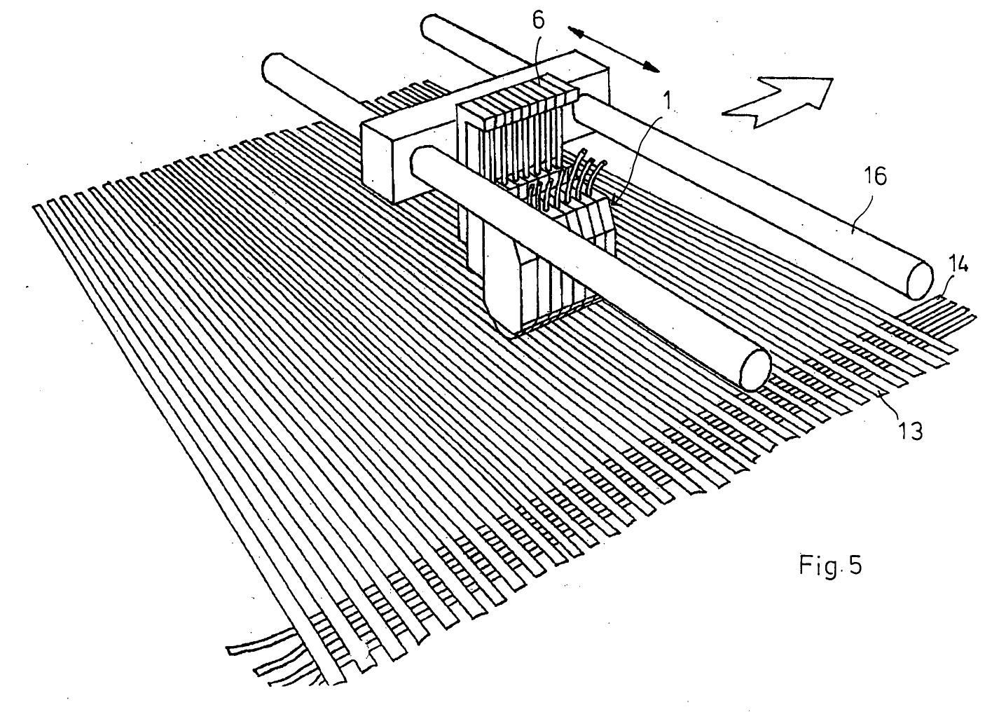

FIG. 5 shows the use over a large area of a plurality of processing heads 1 which are connected to one another, are moved along the material strips 13 and, after the welding operation has been carried out, are set down in the arrow direction on the next row of material strips 13. Guidance along guide bars 16, for example, may be effected in the longitudinal direction of the material strips 13.

1. An apparatus for connecting planar plastic materials by a laser transmission method, wherein a top material layer facing a laser source consists of a material which is transparent for the laser beam and a bottom material layer consists of a material which is absorbent for the laser beam, so that the contact surfaces adjoining one another of the two material layers fuse and combine with one another under pressure during the subsequent cooling, the apparatus comprises a processing head for accommodating guide devices for the laser beam and a device for transmitting the laser beam under the application of pressure to the material layers to be connected, wherein focussing means is arranged in the processing head and a rotatable roller which is transparent for the laser beam is arranged at the outlet end facing the material layers, the means comprises an integrated lens system, during the setting to the focus plane, interacting with the transparent roller, and the processing head having pressure devices for pressing the material layers together during the joining operation.

2. The apparatus as claimed in claim 1, wherein passages for injecting air for mounting the roller are arranged in the processing head.

3. The apparatus as claimed in claim 1, wherein a plurality of processing heads are arranged next to one another.

4. The apparatus as claimed in claim 3, wherein spacer devices are arranged between the processing heads, wherein the spacer devices engaging between the top material layers located under the processing heads.

5. The apparatus as claimed in claim 1, wherein the processing head has an elongated narrow housing, on which a piston/cylinder unit engages in alignment with lateral housing walls.
